(19) United States
(12) Patent Application Publication
(10) Pub. No.: US 2023/0351181 A1
(43) Pub. Date: Nov. 2, 2023

(54) APPROXIMATING ACTIVATION FUNCTIONS WITH TAYLOR SERIES

(71) Applicants: Umer Iftikhar Cheema, Hillsboro, OR (US); Deepak Abraham Mathaikutty, Chandler, AZ (US); Arnab Raha, San Jose, CA (US); Dinakar Kondru, Frisco, TX (US); Raymond Jit-Hung Sung, San Francisco, CA (US); Soumendu Kumar Ghosh, Lafayette, IN (US)

(72) Inventors: Umer Iftikhar Cheema, Hillsboro, OR (US); Deepak Abraham Mathaikutty, Chandler, AZ (US); Arnab Raha, San Jose, CA (US); Dinakar Kondru, Frisco, TX (US); Raymond Jit-Hung Sung, San Francisco, CA (US); Soumendu Kumar Ghosh, Lafayette, IN (US)

(21) Appl. No.: 18/346,992

(22) Filed: Jul. 5, 2023

(51) Int. Cl. G06N 3/08; G06N 3/04

(52) U.S. Cl. CPC G06N 3/08; G06N 3/04

(57) ABSTRACT

An activation function unit can compute activation functions approximated by Taylor series. The activation function unit may include a plurality of compute elements. Each compute element may include two multipliers and an accumulator. The first multiplier may compute intermediate products using an activation, such as an output activation of a DNN layer. The second multiplier may compute terms of Taylor series approximating an activation function based on the intermediate products from the first multiplier and coefficients of the Taylor series. The accumulator may compute a partial sum of the terms as an output of the activation function. The number of the terms may be determined based on a predetermined accuracy of the output of the activation function. The activation function unit may process multiple activations. Different activations may be input into different compute elements in different clock cycles. The activation function unit may compute activation functions with different accuracies.

### TECHNICAL FIELD

This disclosure relates generally to deep neural networks (DNN), and more specifically, approximating activation functions in DNNs with Taylor series.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as a large amount of data to read and write. DNN inference also requires computation of activation functions. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example DNN, in accordance with various embodiments.

FIG. 2 illustrates an example convolution, in accordance with various embodiments.

FIG. 3 is a block diagram of a DNN accelerator, in accordance with various embodiments.

FIG. 4 illustrates an example activation function unit, in accordance with various embodiments.

FIG. 5 illustrates an example operation of the activation function unit with no stall cycle, in accordance with various embodiments.

FIG. 6 illustrates computation of an activation function based on the same accuracy, in accordance with various embodiments.

FIG. 7 illustrates an example operation of the activation function unit with a stall cycle, in accordance with various embodiments.

FIG. 8 illustrates computation of an activation function based on different accuracies, in accordance with various embodiments.

FIG. 9 illustrates a processing element (PE) array, in accordance with various embodiments.

FIG. 10 is a block diagram of a PE, in accordance with various embodiments.

FIG. 11 is a flowchart showing a method of computing activation functions in neural networks, in accordance with various embodiments.

FIG. 12 is a block diagram of an example computing device, in accordance with various embodiments.

### DETAILED DESCRIPTION

Overview

The last decade has witnessed a rapid rise in AI (artificial intelligence) based data processing, particularly based on DNNs. DNNs are widely used in the domains of computer vision, speech recognition, image, and video processing mainly due to their ability to achieve beyond human-level accuracy. The significant improvements in DNN model size and accuracy coupled with the rapid increase in computing power of execution platforms have led to the adoption of DNN applications even within resource constrained mobile and edge devices that have limited energy availability.

A DNN layer may include one or more deep learning operations, such as convolution, pooling, elementwise operation, linear operation, nonlinear operation, and so on. A deep learning operation in a DNN may be performed on one or more internal parameters of the DNNs (e.g., weights), which are determined during the training phase, and one or more activations. An activation may be a data point (also referred to as “data elements” or “elements”). Activations or weights of a DNN layer may be elements of a tensor of the DNN layer. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. A DNN layer may have an input tensor (also referred to as “input feature map (IFM)”) including one or more input activations (also referred to as “input elements”) and a weight tensor including one or more weights. A weight is an element in the weight tensor. A weight tensor of a convolution may be a kernel, a filter, or a group of filters. The output data of the DNN layer may be an output tensor (also referred to as “output feature map (OFM)”) that includes one or more output activations (also referred to as “output elements”).

Activation functions are important parts of DNNs. An activation function can decide whether a neuron should or should not be activated by computing the weighted sum activations and adding bias. An important purpose of activation functions is to introduce non-linearity to the output of neurons. Considering the complexity of some of the nonlinear activation functions used in many DNNs, hardware implementation may require approximation within certain level of accuracy.

Currently available implementations of activation functions are based on Look-up-Table (LUT) of activation functions or DSP (digital signal processor) cores. LUT sometimes employs Piece-wise Linear approximation (PWL). PWL is based on approximating the complex nonlinear curve using several linear segments. Although PWL based LUT approach can simplify the complex computations required for some of the nonlinear functions by approximating using a LUT, address generation logic, and simple arithmetic blocks (e.g., subtractor, multiplier and adder), improving the accuracy of PWL based LUT approach usually requires a greater number of linear segments and hence higher number of entries in the LUT. Since nonlinear approximation is part of the core DNN logic, it may not always be possible to allocate additional area on the DNN accelerator die. For such scenarios, it may be beneficial to trade additional accuracy at the expense of performance without adding any additional area.

A DSP core usually requires kernel implementation of activation functions. DSP based implementations usually require offloading the task from a neural network processor onto the DSP core, which can add additional overheads like handshaking and inter-module communications. Additionally, considering the nature of DSP cores, it may be running at a lower clock frequency compared to the neural network processor. These limitations add in-efficiencies to the computation activation functions within the DNN accelerator.

Embodiments of the present disclosure provide DNN accelerators with activation function units that can compute approximations of activation functions. An approximation of an activation function may be Taylor series. An example DNN accelerator in the present disclosure includes one or more compute blocks. A compute block may also be referred to as a compute tile. Each compute block may be a processing unit. A compute block includes a memory, a PE array, and an activation function unit. The memory may store data received or generated by the compute block. The PE array may perform deep learning operations, such as convolutions, elementwise operations, pooling operations, and so on. The activation function unit may receive output activations computed by the PE array and apply activation function to the output activations. Outputs of the activation function units may be used as inputs to deep learning operations performed by the PE array. Outputs of the activation function unit may be stored in the memory. The activation function may be on a drain path from the PE array to the memory.

In various embodiments of the present disclosure, an activation function unit may include a plurality of compute elements. The compute elements may operate in parallel. Different activations may be input into different compute elements in different clock cycles. A compute element can compute polynomials (e.g., polynomials of Taylor series) that approximate activation functions. The degree of a polynomial or the number of terms in a polynomial may be determined based on a predetermined accuracy of the activation function output. A higher accuracy may require more terms in the polynomial and may need more compute elements or more clock cycles.

An example compute element may include two multipliers and an accumulator. The first multiplier may compute intermediate products using an activation, such as an output activation of a DNN layer. The first multiplier may compute intermediate products for different terms in different clock cycles. For instance, the first multiple may compute the activation squared in the first clock cycle, compute the activation cubed in the second clock cycle, and so on. The second multiplier may compute the terms in the polynomial based on the intermediate products from the first multiplier and coefficients of the Taylor series. In an example clock cycle, the second multiplier may multiply a coefficient with an intermediate product computed by the first multiplier in the previous clock cycle. The second multiplier may transmit the result of the term to the accumulator. The accumulator may compute a partial sum of the terms as an output of the activation function.

The present disclosure provides an approach to compute activation functions based on Taylor series. This approach is capable of programmable accuracy-performance trade-off. Accuracies of the activation functions can be modulated by controlling the number of Taylor series terms to be computed. The accuracy for the outcome of activation function could be improved by adding additional computation cycles. High accuracies can be achieved with minimal performance penalty, such as a performance penalty of a very small number of clock cycles (e.g., one, two, etc.). Therefore, the present disclosure provides an more advantageous technology for computing activation functions than the currently available techniques.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN

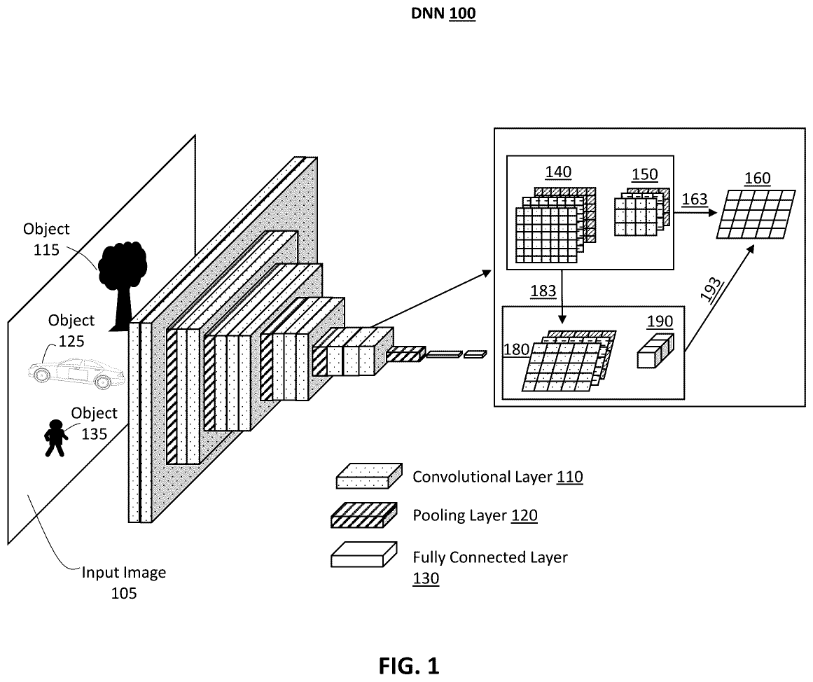

FIG. 1 illustrates an example DNN 100, in accordance with various embodiments. For purpose of illustration, the DNN 100 in FIG. 1 is a CNN. In other embodiments, the DNN 100 may be other types of DNNs. The DNN 100 is trained to receive images and output classifications of objects in the images. In the embodiments of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers. In an inference of the DNN 100, the layers of the DNN 100 execute tensor computation that includes many tensor operations, such as convolution (e.g., multiply-accumulate (MAC) operations, etc.), pooling operations, elementwise operations (e.g., elementwise addition, elementwise multiplication, etc.), other types of tensor operations, or some combination thereof.

The convolutional layers 110 summarize the presence of features in the input image 105. The convolutional layers 110 function as feature extractors. The first layer of the DNN 100 is a convolutional layer 110. In an example, a convolutional layer 110 performs a convolution on an input tensor 140 (also referred to as IFM 140) and a filter 150. As shown in FIG. 1, the IFM 140 is represented by a 7×7×3 three-dimensional (3D) matrix. The IFM 140 includes 3 input channels, each of which is represented by a 7×7 two-dimensional (2D) matrix. The 7×7 2D matrix includes 7 input elements (also referred to as input points) in each row and 7 input elements in each column. The filter 150 is represented by a 3×3×3 3D matrix. The filter 150 includes 3 kernels, each of which may correspond to a different input channel of the IFM 140. A kernel is a 2D matrix of weights, where the weights are arranged in columns and rows. A kernel can be smaller than the IFM. In the embodiments of FIG. 1, each kernel is represented by a 3×3 2D matrix. The 3×3 kernel includes 3 weights in each row and 3 weights in each column. Weights can be initialized and updated by backpropagation using gradient descent. The magnitudes of the weights can indicate importance of the filter 150 in extracting features from the IFM 140.

The convolution includes MAC operations with the input elements in the IFM 140 and the weights in the filter 150. The convolution may be a standard convolution 163 or a depthwise convolution 183. In the standard convolution 163, the whole filter 150 slides across the IFM 140. All the input channels are combined to produce an output tensor 160 (also referred to as output feature map (OFM) 160). The OFM 160 is represented by a 5×5 2D matrix. The 5×5 2D matrix includes 5 output elements (also referred to as output points) in each row and 5 output elements in each column. For purpose of illustration, the standard convolution includes one filter in the embodiments of FIG. 1. In embodiments where there are multiple filters, the standard convolution may produce multiple output channels in the OFM 160.

The multiplication applied between a kernel-sized patch of the IFM 140 and a kernel may be a dot product. A dot product is the elementwise multiplication between the kernel-sized patch of the IFM 140 and the corresponding kernel, which is then summed, always resulting in a single value. Because it results in a single value, the operation is often referred to as the “scalar product.” Using a kernel smaller than the IFM 140 is intentional as it allows the same kernel (set of weights) to be multiplied by the IFM 140 multiple times at different points on the IFM 140. Specifically, the kernel is applied systematically to each overlapping part or kernel-sized patch of the IFM 140, left to right, top to bottom. The result from multiplying the kernel with the IFM 140 one time is a single value. As the kernel is applied multiple times to the IFM 140, the multiplication result is a 2D matrix of output elements. As such, the 2D output matrix (i.e., the OFM 160) from the standard convolution 163 is referred to as an OFM.

In the depthwise convolution 183, the input channels are not combined. Rather, MAC operations are performed on an individual input channel and an individual kernel and produce an output channel. As shown in FIG. 1, the depthwise convolution 183 produces a depthwise output tensor 180. The depthwise output tensor 180 is represented by a 5×5×3 3D matrix. The depthwise output tensor 180 includes 3 output channels, each of which is represented by a 5×5 2D matrix. The 5×5 2D matrix includes 5 output elements in each row and 5 output elements in each column. Each output channel is a result of MAC operations of an input channel of the IFM 140 and a kernel of the filter 150. For instance, the first output channel (patterned with dots) is a result of MAC operations of the first input channel (patterned with dots) and the first kernel (patterned with dots), the second output channel (patterned with horizontal strips) is a result of MAC operations of the second input channel (patterned with horizontal strips) and the second kernel (patterned with horizontal strips), and the third output channel (patterned with diagonal stripes) is a result of MAC operations of the third input channel (patterned with diagonal stripes) and the third kernel (patterned with diagonal stripes). In such a depthwise convolution, the number of input channels equals the number of output channels, and each output channel corresponds to a different input channel. The input channels and output channels are referred to collectively as depthwise channels. After the depthwise convolution, a pointwise convolution 193 is then performed on the depthwise output tensor 180 and a 1×1×3 tensor 190 to produce the OFM 160.

The OFM 160 is then passed to the next layer in the sequence. In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculate the convolution of each of them with each of the kernels. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 perform a convolution on the OFM 160 with new kernels and generates a new feature map. The new feature map may also be normalized and resized. The new feature map can be kernelled again by a further subsequent convolutional layer 110, and so on.

In some embodiments, a convolutional layer 110 has 4 hyperparameters: the number of kernels, the size F kernels (e.g., a kernel is of dimensions F×F×D pixels), the S step with which the window corresponding to the kernel is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depthwise separable convolution, transposed convolution, and so on. The DNN 100 includes 16 convolutional layers 110. In other embodiments, the DNN 100 may include a different number of convolutional layers.

The pooling layers 120 down-sample feature maps generated by the convolutional layers, e.g., by summarizing the presence of features in the patches of the feature maps. A pooling layer 120 is placed between 2 convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU, etc.) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of 2 pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receive an input operand. The input operand defines the output of the convolutional layers 110 and pooling layers 120 and includes the values of the last feature map generated by the last pooling layer 120 in the sequence. The fully connected layers 130 apply a linear combination and an activation function to the input operand and generate a vector. The vector may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and return an operand of size N, where N is the number of classes in the image classification problem. In the embodiments of FIG. 1, N equals 3, as there are 3 objects 115, 125, and 135 in the input image. Each element of the operand indicates the probability for the input image 105 to belong to a class. To calculate the probabilities, the fully connected layers 130 multiply each input element by weight, make the sum, and then apply an activation function (e.g., logistic if N=2, softmax if N>2). This is equivalent to multiplying the input operand by the matrix containing the weights. In an example, the vector includes 3 probabilities: a first probability indicating the object 115 being a tree, a second probability indicating the object 125 being a car, and a third probability indicating the object 135 being a person. In other embodiments where the input image 105 includes different objects or a different number of objects, the individual values can be different.

Example Convolution

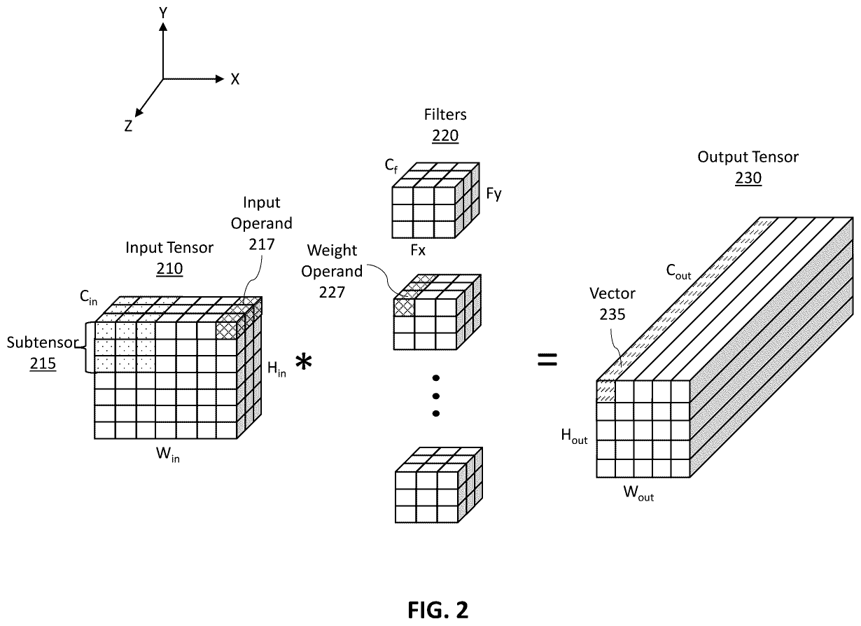

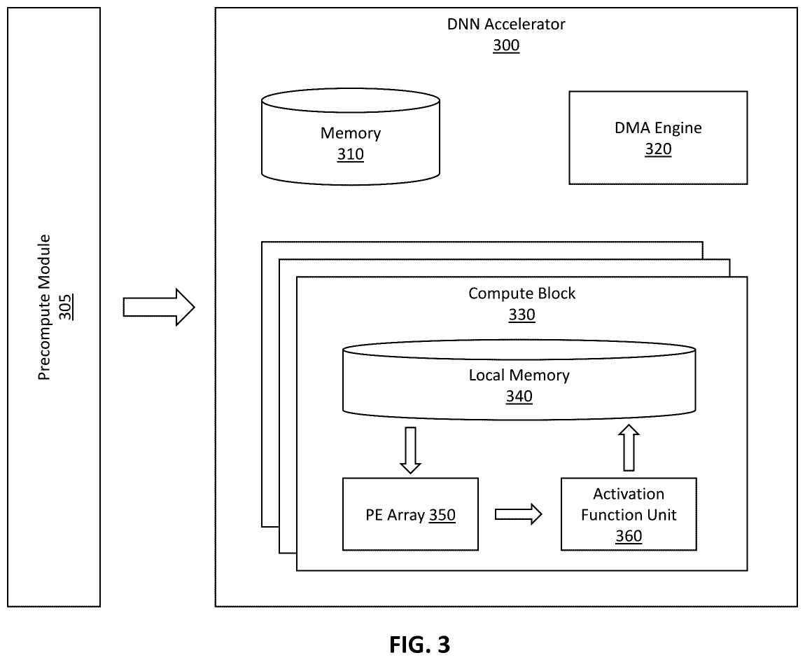

FIG. 2 illustrates an example convolution, in accordance with various embodiments. The convolution may be a convolution in a convolutional layer of a DNN, e.g., a convolutional layer 110 in FIG. 1. The convolution can be executed on an input tensor 210 and filters 220 (individually referred to as “filter 220”). A result of the convolution is an output tensor 230. In some embodiments, the convolution is performed by a DNN accelerator including one or more compute tiles. An example of the DNN accelerator may be the DNN accelerator 300 in FIG. 3. A compute tile may be a compute block, such as the compute block 330 in FIG. 3.

In the embodiments of FIG. 2, the input tensor 210 includes activations (also referred to as “input activations,” “elements,” or “input elements”) arranged in a 3D matrix. An input element is a data point in the input tensor 210. The input tensor 210 has a spatial size Hᵢₙ×Wᵢₙ×Cᵢₙ, where Hᵢₙ is the height of the 3D matrix (i.e., the length along the Y axis, which indicates the number of activations in a column in the 2D matrix of each input channel), Wᵢₙ is the width of the 3D matrix (i.e., the length along the X axis, which indicates the number of activations in a row in the 2D matrix of each input channel), and Cᵢₙ is the depth of the 3D matrix (i.e., the length along the Z axis, which indicates the number of input channels). For purpose of simplicity and illustration, the input tensor 210 has a spatial size of 7×7×3, i.e., the input tensor 210 includes three input channels and each input channel has a 7×7 2D matrix. Each input element in the input tensor 210 may be represented by a (X, Y, Z) coordinate. In other embodiments, the height, width, or depth of the input tensor 210 may be different.

Each filter 220 includes weights arranged in a 3D matrix. The values of the weights may be determined through training the DNN. A filter 220 has a spatial size H_{ƒ}×W_{ƒ}×C_{ƒ}, where Hf is the height of the filter (i.e., the length along the Y axis, which indicates the number of weights in a column in each kernel), W_{ƒ} is the width of the filter (i.e., the length along the X axis, which indicates the number of weights in a row in each kernel), and C_{ƒ} is the depth of the filter (i.e., the length along the Z axis, which indicates the number of channels). In some embodiments, C_{ƒ} equals Cᵢₙ. For purpose of simplicity and illustration, each filter 220 in FIG. 2 has a spatial size of 3×3×3, i.e., the filter 220 includes 3 convolutional kernels with a spatial size of 3×3. In other embodiments, the height, width, or depth of the filter 220 may be different. The spatial size of the convolutional kernels is smaller than the spatial size of the 2D matrix of each input channel in the input tensor 210.

An activation or weight may take one or more bytes in a memory. The number of bytes for an activation or weight may depend on the data format. For example, when the activation or weight has a INT8 format, the activation takes one byte. When the activation or weight has a FP16 format, the activation or weight takes two bytes. Other data formats may be used for activations or weights.

In the convolution, each filter 220 slides across the input tensor 210 and generates a 2D matrix for an output channel in the output tensor 230. In the embodiments of FIG. 2, the 2D matrix has a spatial size of 5×5. The output tensor 230 includes activations (also referred to as “output activations,” “elements,” or “output element”) arranged in a 3D matrix. An output activation is a data point in the output tensor 230. The output tensor 230 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 2D matrix of each output channel), Wₒᵤₜ is the width of the 3D matrix (i.e., the length along the X axis, which indicates the number of output activations in a row in the 2D matrix of each output channel), and cut is the depth of the 3D matrix (i.e., the length along the Z axis, which indicates the number of output channels). Cₒᵤₜ may equal the number of filters 220 in the convolution. Hₒᵤₜ and Wₒᵤₜ may depend on the heights and weights of the input tensor 210 and each filter 220.

As a part of the convolution, MAC operations can be performed on a 3×3×3 subtensor 215 (which is highlighted with a dotted pattern in FIG. 2) in the input tensor 210 and each filter 220. The result of the MAC operations on the subtensor 215 and one filter 220 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 215 and all the filters 220 are finished, a vector 235 is produced. The vector 235 is highlighted with slashes in FIG. 2. The vector 235 includes a sequence of output activations, which are arranged along the Z axis. The output activations in the vector 235 have the same (x, y) coordinate, but the output activations correspond to different output channels and have different Z coordinates. The dimension of the vector 235 along the Z axis may equal the total number of output channels in the output tensor 230. After the vector 235 is produced, further MAC operations are performed to produce additional vectors till the output tensor 230 is produced.

In some embodiments, the MAC operations on a 3×3×3 subtensor (e.g., the subtensor 215) and a filter 220 may be performed by a plurality of PEs. One or more PEs may receive an input operand (e.g., an input operand 217 shown in FIG. 2) and a weight operand (e.g., the weight operand 227 shown in FIG. 2). The input operand 217 includes a sequence of activations having the same (x, y) coordinate but different z coordinates. The input operand 217 includes an activation from each of the input channels in the input tensor 210. The weight operand 227 includes a sequence of weights having the same (x, y) coordinate but different z coordinates. The weight operand 227 includes a weight from each of the channels in the filter 220. Activations in the input operand 217 and weights in the weight operand 227 may be sequentially fed into a PE. The PE may receive a pair of an activation and a weight at a time and multiple the activation and the weight. The position of the activation in the input operand 217 may match the position of the weight in the weight operand 227. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

In some embodiments, the output activations in the output tensor 230 may be further processed based on one or more activation functions before they are stored or inputted into the next layer of the DNN. The processing based on the one or more activation functions may be at least part of the post processing of the convolution. In some embodiments, the post processing may include one or more other computations, such as offset computation, bias computation, and so on. The results of the post processing may be stored in a local memory of the compute block and be used as input to the next DNN layer. In some embodiments, the input activations in the input tensor 210 may be results of post processing of the previous DNN layer.

Computation of activation functions may be based on Taylor series. In some embodiments, a Taylor series is used to approximate the activation function. The Taylor series may be an infinite sum of terms that are expressed in terms of a function's derivatives at a single point. An activation function ƒ(x) approximated by a Taylor series may be denoted as:

$$f ( x ) = {\sum }_{n = 0}^{∞} \frac{{f}^{( n )} ( a )}{n !} {( x - a )}^{n}$$

where x denotes an input to the activation function; a denotes the power series, which is a real or complex number; and ƒ⁽ⁿ⁾(α) denotes the nth derivative of the function ƒ evaluated at point α.

The activation may be approximated by using the first t terms of the Taylor series. The accuracy of the activation function can be modulated by changing t. As t increases, the accuracy of the approximated activation function increases. The accuracy of the activation function and t may be predetermined, e.g., determined before the activation function is computed. The first t terms may constitute a polynomial of the Taylor series, which is also referred to as a Taylor polynomial. The degree of the polynomial may equal t−1, An example Taylor polynomial having a degree of six and including the first seven terms of the Taylor series may be expressed as:

$$f ( a ) + \frac{{f}^{′} ( a )}{1 !} ( x - a ) + \frac{{f}^{″} ( a )}{2 !} {( x - a )}^{2} + \frac{{f}^{″} ( a )}{3 !} {( x - a )}^{3} + \frac{{f}^{″} ( a )}{4 !} {( x - a )}^{4} + \frac{{f}^{″} ( a )}{5 !} {( x - a )}^{5} + \frac{{f}^{″} ( α )}{6 !} {( x - a )}^{6}$$

Taylor series approximating an activation function involves computation of the first t terms. In some embodiments (e.g., embodiments where a is zero), the terms are the powers of x multiplied by the coefficient that can be precomputed. A partial sum of the first t terms is the approximated output of the activation function.

Example activation functions that can be approximated by Taylor series include ReLU, Tanh activation function, Gaussian error linear unit (GELU), Sigmoid activation function, Sigmoid linear unit (SiLU), and so on. In an example, the Taylor series expansion of a Tanh activation function may be denoted as:

$$tanh x = x - \frac{{x}^{3}}{3} + \frac{2 {x}^{5}}{15} - \frac{17 {x}^{7}}{315} + … = {\sum }_{n = 1}^{∞} \frac{{2}^{2 n} ( {2}^{2 n} - 1 ) {B}_{2 n} {x}^{2 n - 1}}{( 2 n ) !} , \vert x \vert < \frac{π}{2}$$

where B is the Bernoulli number. A GELU activation function may be computed from a Tanh activation function:

GELU(x)=0.5x(1+tan h[\sqrt{2/π}(x+0.044715x³])

A SiLU activation function may be denoted as:

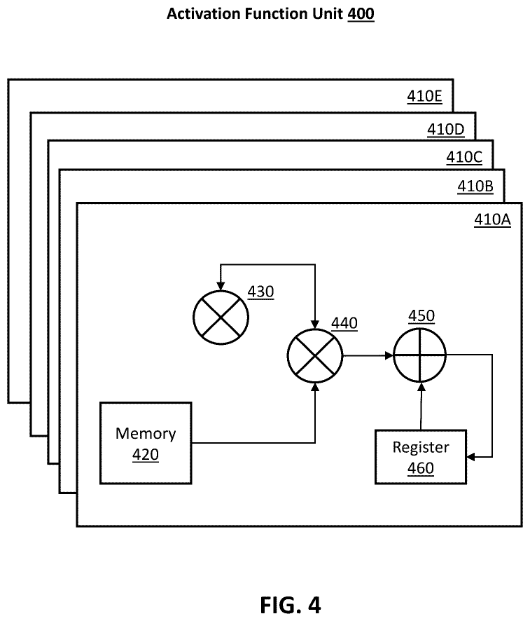

SiLU(x)=xσ′(x)

where σ′(x) can be approximated using Taylor series. More details regarding approximation of activation function with Taylor series are provided below in conjunction with FIGS. 4-8.

Example DNN Accelerator

FIG. 3 is a block diagram of an example DNN accelerator 300, in accordance with various embodiments. The DNN accelerator 300 can execute deep learning operations and activation function in DNNs, e.g., the DNN 100 in FIG. 1. As shown in FIG. 3, the DNN accelerator 300 includes a memory 310, a DMA (direct memory access) engine 320, and compute blocks 330 (individually referred to as “compute block 330”). In other embodiments, alternative configurations, different or additional components may be included in the DNN accelerator 300. For example, the DNN accelerator 300 may include more than one memory 310 or DMA engine 320. As another example, the DNN accelerator 300 may include a single compute block 330. Further, functionality attributed to a component of the DNN accelerator 300 may be accomplished by a different component included in the DNN accelerator 300 or by a different system. A component of the DNN accelerator 300 may be implemented in hardware, software, firmware, or some combination thereof.

The DNN accelerator 300 is associated with a precompute module 305 in the embodiments of FIG. 3. In other embodiments, functionality attributed to a component of the precompute module 305 may be accomplished by the DNN accelerator 300 or by a different system. The precompute module 305 may compute variables to be used by the DNN accelerator 300 for DNN inference. As the computation is before the DNN inference, the computation is referred to as precomputation. The precompute module 305 may perform precomputation for activation functions in DNNs, such as activation functions approximated by Taylor series. For instance, the precompute module 305 may determine the number of terms in a Taylor series that are to be computed by the DNN accelerator 300 during the DNN inference. The precompute module 305 may determine the number of to-be-computed terms (t) based on a predetermined accuracy of the corresponding activation function. The accuracy of the corresponding activation function may have been determined based on the target accuracy of the DNN or other factors.

In some embodiments, the precompute module 305 may use obtain data indicating a correlation between t and activation function accuracies. In an example, the precompute module 305 may use obtain a curve showing how the activation function accuracy changes as t changes. The precompute module 305 may determine the value of t based on the curve and the predetermined accuracy of the activation function.

In some embodiments, the precompute module 305 may also precompute coefficients of the Taylor series before the DNN accelerator 300 computes the first t terms of the Taylor series. In some embodiments, a coefficient may be denoted as:

$$\frac{{f}^{( n )} ( a )}{n !}$$

where n denotes an integer in the range from one to t. The precompute module 305 may determine the value of α. In some embodiments, the value of α may be zero.

The memory 310 stores data associated with deep learning operations (including activation functions) performed by the DNN accelerator. In some embodiments, the memory 310 may store data to be used by the compute blocks 330 for DNN inference. For example, the memory 310 may store data computed by the precompute module 305, such as coefficients of Taylor series. As another example, the memory 310 may store weights, such as weights of convolutional layers, which are determined by training DNNs. The memory 310 may also store data generated by the compute blocks 330 from performing deep learning operations in DNNs. Example deep learning operations include convolutions (also referred to as “convolutional operations”), pooling operations, elementwise operations, activation functions, other types of deep learning operations, or some combination thereof. The memory 310 may be a main memory of the DNN accelerator 300. In some embodiments, the memory 310 includes one or more DRAMs (dynamic random-access memory).

The DMA engine 320 facilitates data transfer between the memory 310 and local memories of the compute blocks 330. For example, the DMA engine 320 can read data from the memory 310 and write data into a local memory of a compute block 330. As another example, the DMA engine 320 can read data from a local memory of a compute block 330 and write data into the memory 310. The DMA engine 320 provides a DMA feature that allows the compute block 330 to initiate data transfer between the memory 310 and the local memories of the compute blocks 330 and to perform other operations while the data transfer is in being conducted. In some embodiments, the DMA engine 320 may read tensors from the memory 310, modify the tensors in a way that is optimized for the compute block 330 before it writes the tensors into the local memories of the compute blocks 330.

The compute blocks 330 can perform deep learning operations in DNNs. For instance, a compute block 330 may run a deep learning operation in a DNN layer, or a portion of the deep learning operation, at a time. The compute blocks 330 may be capable of running various types of deep learning operations, such as convolution, pooling, elementwise operation, linear operation, nonlinear operation, and so on. In an example, a compute block 330 may perform convolutions, e.g., standard convolution or depthwise convolution. In some embodiments, the compute block 330 receives an input tensor and one or more convolutional kernels and performs a convolution with the input tensor and convolutional kernels. The result of the convolution may be an output tensor, which can be further computed, e.g., by the compute block 330 or another compute block 330. In some embodiments, the operations of the DNN layers may be run by multiple compute blocks 330 in parallel. For instance, multiple compute blocks 330 may each perform a portion of a workload for a convolution. Data may be shared between the compute blocks 330.

In the embodiments of FIG. 3, each compute block 330 includes a local memory 340, a PE array 350, and an activation function unit 360. The local memory 340, PE array 350, and activation function unit 360 can be implemented on the same chip. In other embodiments, alternative configurations, different or additional components may be included in the compute block 330. Further, functionality attributed to a component of the compute block 330 may be accomplished by a different component included in the compute block 330 or the DNN accelerator 300 or by a different system. A component of the compute block 330 may be implemented in hardware, software, firmware, or some combination thereof.

The local memory 340 is local to the corresponding compute block 330. In the embodiments of FIG. 3, the local memory 340 is inside the compute block 330. In other embodiments, the local memory 340 may be outside the compute block 330. The local memory 340 may store data received, used, or generated by the PE array 350 and the activation function unit 360. Examples of the data may include input activations, weights, output activations, coefficients of Taylor series, results of activation functions, sparsity bitmaps, and so on. Data in the local memory 340 may be transferred to or from the memory 310, e.g., through the DMA engine 320. In some embodiments, data in the local memory 340 may be transferred to or from the local memory of another compute block 330.

In some embodiments, the local memory 340 includes one or more static random-access memories (SRAMs). The local memory 340 may be byte-addressable, and each memory address identifies a single byte (eight bits) of storage. In some embodiments, the local memory 340 may include memory banks. The number of data banks in the local memory 340 may be 16, 64, 128, 256, 512, 1024, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 340 in a single read cycle. In other embodiments, 16 bits can be transferred from the local memory 340 in multiple read cycles, such as two cycles.

The PE array 350 may include PEs arranged in columns, or columns and rows. Each PE can perform MAC operations. In some embodiments, a PE includes one or more multipliers for performing multiplications. An PE may also include one or more accumulators (“adders”) for performing accumulations. A column of PEs is referred to as a PE column. A PE column may be associated with one or more MAC lanes. A MAC lane is a path for loading data into a MAC column. A MAC lane may be also referred to as a data transmission lane or data loading lane. A PE column may have multiple MAC lanes. The loading bandwidth of the MAC column is an aggregation of the loading bandwidths of all the MAC lanes associated with the MAC column. With a certain number of MAC lanes, data can be fed into the same number of independent PEs simultaneously. In some embodiments where a MAC column has four MAC lanes for feeding activations or weights into the MAC column and each MAC lane may have a bandwidth of 16 bytes, the four MAC lanes can have a total loading bandwidth of 64 bytes.

In some embodiments, the PE array 350 may be capable of depthwise convolution, standard convolution, or both. In a depthwise convolution, a PE may perform an MAC operation that includes a sequence of multiplications for an input operand and a weight operand. Each multiplication in the sequence (also referred to as a cycle) is a multiplication of a different activation in the input operand with a different weight in the weight operand. The activation and weight in the same cycle may correspond to the same channel. The sequence of multiplication produces a product operand that includes a sequence of products. The MAC operation may also include accumulations in which multiple product operands are accumulated to produce an output operand of the PE. The PE array 350 may output multiple output operands at a time, each of which is generated by a different PE. In a standard convolution, MAC operations may include accumulations across the channels. For instance, as opposed to generating an output operand, a PE may accumulate products across different channels to generate a single output point.

In some embodiments, the PE array 350 may perform MAC operations in quantized inference, such as MAC operations in a quantized convolution. In some embodiments, a PE in the PE array 350 may receive quantized activation and quantized weights and compute a quantized MAC result. The quantized MAC result may be a quantized value in an integer format and may be the output of the PE. In some embodiments, the PE may also include a quantization multiplier that can multiply a quantization scale with the quantized MAC result, and the output of the PE may be a real value in a floating-point format. The PE may include no quantization subtractors as zero-point offsetting is not needed for the MAC operations in quantized inference.

The activation function unit 360 computes activation functions. The activation function unit 360 may receive outputs of the PE array 350 as inputs to the activation functions. The activation function unit 360 may transmit the outputs of the activation functions to the local memory 340. The outputs of the activation functions may be retrieved later by the PE array 350 from the local memory 340 for further computation. For instance, the activation function unit 360 may receive an output tensor of a DNN layer from the PE array 350 and computes one or more activation functions on the output tensor. The results of the computation by the activation function unit 360 may be stored in the local memory 340 and later used as input tensor of the next DNN layer. In some embodiments, the local memory 340 is associated with a load path and a drain path may be used for data transfer within the compute block 330. For instance, data may be transferred from the local memory 340 to the PE array 350 through the load path. Data may be transferred from the PE array 350 to the local memory 340 through the drain path. The activation function unit 360 (and optionally one or more other post processing units) may be arranged on the drain path for processing outputs of the PE array before the data is written into the local memory 340.

In some embodiments, the activation function unit 360 may compute activation functions approximated by Taylor series, e.g., based on precomputed data generated by the precompute module 305. For instance, the activation function unit 360 may compute one or more terms in the Taylor series by multiplying one or more coefficients of the Taylor series with one or more powers of an input to the activation function unit 360. The activation function unit 360 may include one or more multipliers that can multiply the coefficients with the powers of the input. The input may be an activation computed by the PE array 350, such as an output activation of a convolution. The activation function unit 360 may further compute a partial sum of the one or more terms as the output of the activation function. The outputs of the activation function unit 360 may be written into the local memory 340. In some embodiments, the outputs of the activation function unit 360 may be read from the local memory 340 for future computation by the PE array 350. Certain aspects of the activation function unit 360 are described below in conjunction with FIGS. 4-8.

Example Activation Function Unit

FIG. 4 illustrates an example activation function unit 400, in accordance with various embodiments. The activation function unit 400 may be an embodiment of the activation function unit 360 in FIG. 3. As shown in FIG. 4, the activation function unit 400 includes a plurality of compute elements 410A-410E (collectively referred to as “compute elements 410” or “compute element 410”). Even though FIG. 4 shows five compute elements 410, the activation function unit 400 may include a different number of compute elements 410 in other embodiments.

The compute elements 410 may operate in parallel. The operations of the compute elements 410 may be independent from each other. In some embodiments, the compute elements 410 receives different activations from the PE array 350. In an embodiment, each compute element 410 may receive a different activation in an output tensor computed by the PE array 350. In another embodiment, two or more of the compute elements 410 may process the same activation. In some embodiments, different compute elements 410 may receive activations at different times, e.g., in different clock cycles.

A compute element 410 includes a memory 420, multipliers 430 and 440, an accumulator 450, and a register 460. In other embodiments, a compute element 410 may include different, fewer, or more components. Further, functionality attributed to a component of the compute element 410 may be accomplished by a different component included in the compute element 410 or by a different system or device.

The memory 420 stores coefficients of Taylor series, which may be from the precompute module 305. Even though the memory 420 is in the compute element 410 in FIG. 4, the memory 420 may not be included in the compute element 410 or even not included in the activation function unit 400. In some embodiments, the memory 420 may be the memory 310 or the local memory 340.

The multiplier 430 may receive activations from the PE array 350. In some embodiments, the multiplier 430 may compute a single activation at a time. The multiplier 430 may compute one or more powers of the activation. The multiplier 430 may sequentially compute powers of the activations. In an example, the multiplier 430 may compute a power of the activation in a computation cycle, e.g., a clock cycle. The exponent of the power of the activation computed in a cycle may be higher than the power of the activation computed in the previous cycle, e.g., higher by one.

The multiplier 440 multiplies outputs of the multiplier 430 with coefficients of Taylor series form the memory 420. In an example, the multiplier 440 may multiply a power of an activation with a corresponding coefficient of the Taylor series in a cycle. The output of the multiplier 440 in the cycle may be the result of a term in the Taylor series. In some embodiments, the multiplier 440 may compute a term in a cycle.

The accumulator 450 receives outputs of the multiplier 440 and generates a partial sum of terms in the Taylor series as the result of the activation function. In some embodiments, the accumulator 450 may receive an output of the multiplier 440 in a cycle. In the cycle, the accumulator 450 may accumulate the output of the multiplier 440 with a sum computed by the accumulator 450 in a previous cycle. The sum from the previous cycle may be stored in the register 460. The new sum may also be stored in the register 460 and be further accumulated with an output of the multiplier 440 in the next cycle. This process may continue till the partial sum of all the required terms of the Taylor series is computed.

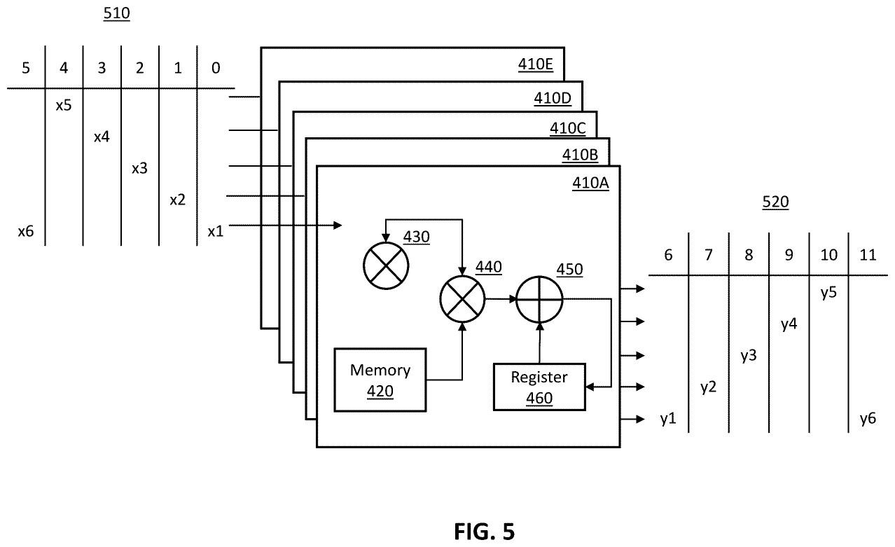

FIG. 5 illustrates an example operation of the activation function unit 400 with no stall cycle, in accordance with various embodiments. The operation of the activation function unit 400 includes 12 clock cycles: 0-11. In the 12 clock cycles, the activation function unit 400 processes six activations and computes six results of an activation function. FIG. 5 shows two tables 510 and 520. The table 510 shows inputs of the activation function unit 400 in six clock cycles: 0-5. The table 520 shows outputs of the activation function unit 400 in six clock cycles: 6-11. In other embodiments, the operation of the activation function unit 400 may include different, fewer, or more cycles.

The table 510 shows six activations: x1-x6. In some embodiments, the six activations may be in an output operand computed by the PE array 350, e.g., through performing a convolution. In the embodiments of FIG. 5, the activation function unit 400 receives a new activation in each of the six cycles: the activation x1 is received in cycle 0, the activation x2 is received in cycle 1, the activation x3 is received in cycle 2, the activation x4 is received in cycle 3, the activation x5 is received in cycle 4, the activation x6 is received in cycle 5. Even though not shown in FIG. 5, the activation function unit 400 may receive more activations in future cycles. The activations are input into different compute elements 410 of the activation function unit 400. The first five activations x1-x5 are respectively input into the five compute elements 410. The sixth activation x6 is input into the compute element 410A.

The table 520 shows six outputs: y1-y6, each of which is computed by using a corresponding activation. The output y1 corresponds to the activation x1, the output y2 corresponds to the activation x2, the output y3 corresponds to the activation x3, the output y4 corresponds to the activation x4, the output y5 corresponds to the activation x5, and the output y6 corresponds to the activation x6. Also, the outputs y1-y6 are generated in different cycles. The output y1 is computed in cycle 6, the output y2 is computed in cycle 7, the output y3 is computed in cycle 8, the output y4 is computed in cycle 9, the output y5 is computed in cycle 10, and the output y6 is computed in cycle 11.

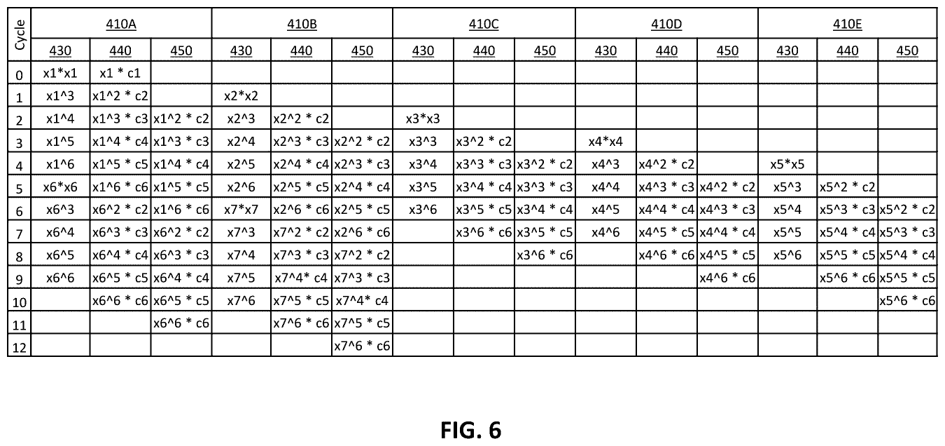

FIG. 6 illustrates computation of an activation function based on the same accuracy, in accordance with various embodiments. The computation is done by the activation function unit 400. FIG. 6 is a table that lists the computations performed in the multipliers 430 and 440 and accumulator 450 in each of the compute elements 410 in the activation function unit 400. In the embodiments of FIG. 6, each compute element 410 computes a partial sum of the first six terms in the Taylor series. The first six terms constitute a Taylor polynomial with a degree of five. The compute element 410A receives the activation x1 in cycle 0. In each of the cycles 0-4, the multiplier 430 computes an intermediate product, which is a power of x1. In the first cycle right after the cycle in which an intermediate product is computed, the multiplier 440 receives the intermediate product from the multiplier 430 and multiplies the intermediate product with one of six coefficients of the Taylor series, which are represented as c1-c6 in FIG. 6. The product computed by the multiplier 440 is the result of a term in the Taylor series. The accumulator 450 receives the result of the term in the second cycle after the cycle in which an intermediate product is computed. The accumulator 450 accumulates the result of the term with an output of the accumulator 450 in the first cycle right after the cycle in which an intermediate product is computed. The accumulator 450 outputs the result of the activation function for x1 in cycle 6.

The compute element 410B receives the activation x2 in cycle 1 and outputs the result of the activation function for x2 in cycle 7. The compute element 410C receives the activation x3 in cycle 2 and outputs the result of the activation function for x3 in cycle 8. The compute element 410D receives the activation x4 in cycle 3 and outputs the result of the activation function for x4 in cycle 9. The compute element 410E receives the activation x5 in cycle 4 and outputs the result of the activation function for x5 in cycle 10.

A compute element 410 may start to process a new activation in the cycle right after the multiplier 430 computes the last intermediate product for the activation. As shown in FIG. 6, the compute element 410A receives the activation x6 in cycle 5, even though the multiplier 440 and the accumulator 450 are still processing the activation x1. The compute element 410A outputs the result of the activation function for x6 in cycle 11. Similarly, the compute element 410B receives the activation x7 in cycle 6 and outputs the result of the activation function for x7 in cycle 12. Even though not shown in FIG. 6, the activation function unit 400 may process more activations.

In the embodiments of FIG. 6, the seven results of the activation function have the same accuracy and the same number of terms are computed for all the seven activations. In other embodiments, different activations may be processed by the activation function unit 400 based on different accuracies.

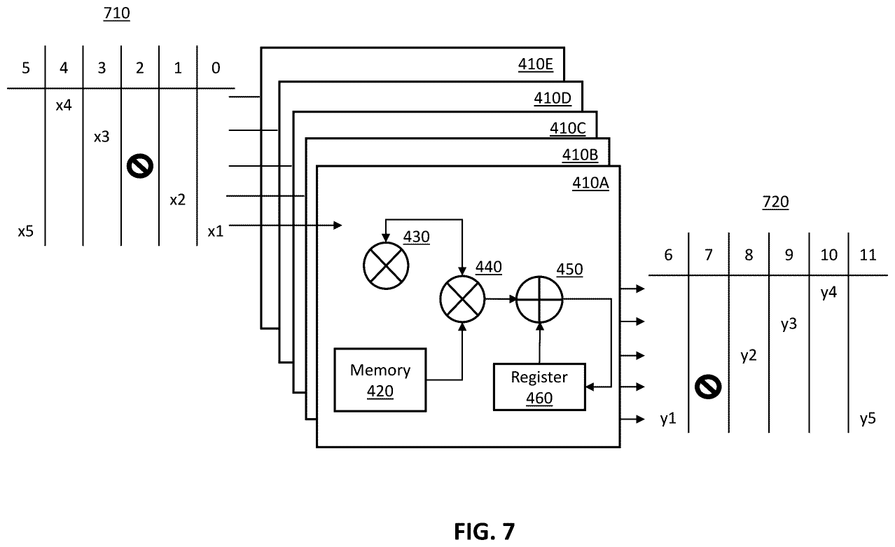

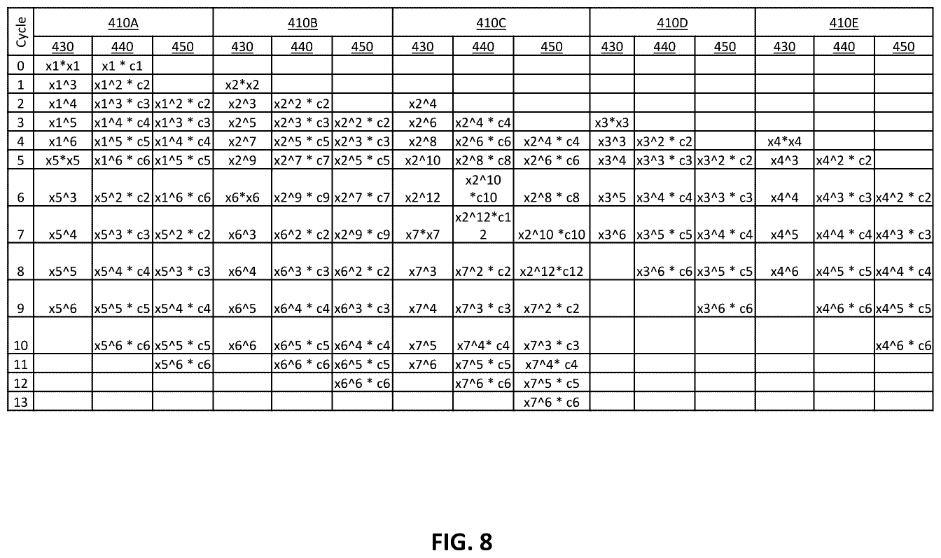

FIG. 7 illustrates an example operation of the activation function unit 400 with a stall cycle, in accordance with various embodiments. In the operation illustrated in FIG. 7, the activation function unit 400 processes five activations x1-x5 and computes five results y1-y5 of the activation function. The operation of the activation function unit 400 includes 12 clock cycles: 0-11, but the cycle 2 is a stall cycle as the activation function unit 400 does not receive any new activation, causing no output in cycle 7. The presence of the stall cycles may be for facilitating a higher accuracy of the result y2 than the other results. The higher accuracy requires computation of more terms in the Taylor series, and more clock cycles are taken to compute the result y2. More details regarding stalling clock cycles for achieving higher accuracies are described below in conjunction with FIG. 8.

FIG. 7 shows two tables 710 and 720. The table 710 shows six clock cycles 0-6, in which activation function unit 400 receives the five activations x1-x5. The activation function unit 400 receives a different activation in each of cycles 0, 1, and 3-5. The table 720 shows six clock cycles 6-12, in which activation function unit 400 outputs the five results y1-y5. The activation function unit 400 outputs a different result in each of cycles 6 and 8-11. In other embodiments, the operation of the activation function unit 400 may include different, fewer, or more cycles.

In some embodiments, the five activations x1-x5 may be in an output operand computed by the PE array 350, e.g., through performing a convolution. The activations may be input into different compute elements 410 of the activation function unit 400. The first five activations x1-x5 are respectively input into the five compute elements 410. Each of the results y1-y6 is computed by using a corresponding activation. The output y1 corresponds to the activation x1, the output y2 corresponds to the activation x2, the output y3 corresponds to the activation x3, the output y4 corresponds to the activation x4, and the output y5 corresponds to the activation x5.

FIG. 8 illustrates computation of an activation function based on different accuracies, in accordance with various embodiments. The computation is done by the activation function unit 400. FIG. 8 is a table that lists the computations performed in the multipliers 430 and 440 and accumulator 450 in each of the compute elements 410 in the activation function unit 400. In the embodiments of FIG. 8, each compute element 410 computes a partial sum of the first six terms in the Taylor series. The first six terms constitute a Taylor polynomial with a degree of five. The compute element 410A receives the activation x1 in cycle 0. In each of the cycles 0-4, the multiplier 430 computes an intermediate product, which is a power of x1. In the first cycle right after the cycle in which an intermediate product is computed, the multiplier 440 receives the intermediate product from the multiplier 430 and multiplies the intermediate product with one of six coefficients of the Taylor series, which are represented as c1-c6 in FIG. 8. The product computed by the multiplier 440 is the result of a term in the Taylor series. The accumulator 450 receives the result of the term in the second cycle after the cycle in which an intermediate product is computed. The accumulator 450 accumulates the result of the term with an output of the accumulator 450 in the first cycle right after the cycle in which an intermediate product is computed. The accumulator 450 outputs the result of the activation function for x1 in cycle 6.

The compute elements 410B and 410C process the activation x2, which requires a higher accuracy and therefore, more terms in the Taylor series need to be computed. In the embodiments of FIG. 8, the first 12 terms in the Taylor series are computed for the activation x2. The first 12 terms constitute a Taylor polynomial with a degree of 11. The compute element 410B receives the activation x2 in cycle 1 and computes some of the 12 terms. The compute elements 410C receives the activation x2 in cycle 2 and computes other ones of the 12 terms. In cycle 8, the compute element 410C outputs the result of the activation function for x2.

The other activations x3, x4, and x5 have the same accuracy as the activation x1 and therefore, are each computed by a single compute element 410 like the activation x1. The compute element 410D receives the activation x3 in cycle 3 and outputs the result of the activation function for x3 in cycle 9. The compute element 410E receives the activation x4 in cycle 5 and outputs the result of the activation function for x4 in cycle 10.

A compute element 410 may start to process a new activation in the cycle right after the multiplier 430 computes the last intermediate product for the activation. As shown in FIG. 8, the compute element 410A receives the activation x5 in cycle 5, even though the multiplier 440 and the accumulator 450 are still processing the activation x1. The compute element 410A outputs the result of the activation function for x5 in cycle 11. Similarly, the compute element 410B receives the activation x6 in cycle 6 and outputs the result of the activation function for x6 in cycle 12. The compute element 410C receives the activation x7 in cycle 7 and outputs the result of the activation function for x7 in cycle 13. Even though not shown in FIG. 8, the activation function unit 400 may process more activations.

Even though the activation function unit 400 processes the same number of activations in FIGS. 7 and 8, due to the addition accuracy of the result for the activation x2, the activation x2 is iterated for two computation cycles and the operation of the activation function unit 400 in FIG. 8 requires one extra cycle.

In some embodiment, e.g., embodiments where the total number of inputs is n and for an input xᵢ, at least kᵢ additional terms are needed for desired accuracy, then the overall number of clock cycles N may be denoted as:

N=n+t+Σₓ_{ᵢ}[(kᵢ/t)]−1

There may be a linear trade-off between performance (e.g., the number of clock cycles) and accuracy in terms of number of terms within Taylor series. For the same number of computational resources, k additional Taylor series terms can be computed by adding an overhead of k/t cycles instead of k additional cycles. For an input size n=64 (i.e., 64 activations inputted into the activation function unit 400), in an embodiment where 16 additional terms are required to meet the higher accuracy requirement, this translates to approximately 49% reduction in the number of clock cycles required to compute using the same amount of hardware resources.

Example PE Array

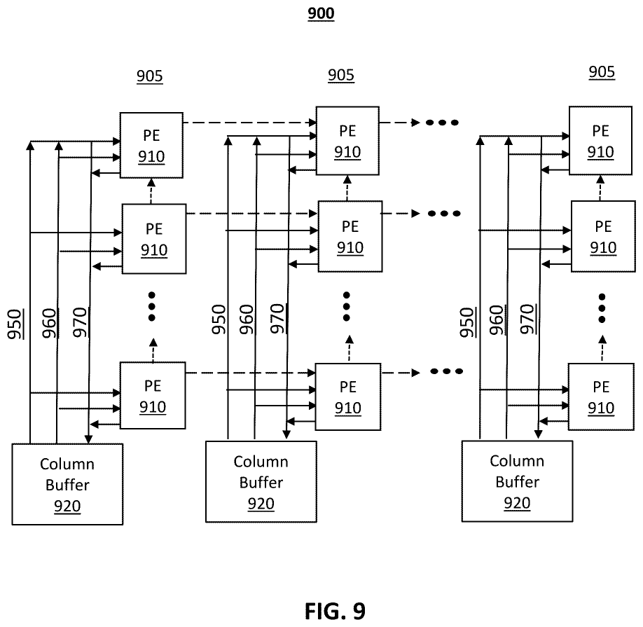

FIG. 9 illustrates a PE array, in accordance with various embodiments. The PE array 900 may be an embodiment of the PE array 350 in FIG. 3. The PE array 900 includes a plurality of PEs 910 (individually referred to as “PE 910”). The PEs 910 can perform MAC operations, including MAC operations in quantized inference. The PEs 910 may also be referred to as neurons in the DNN. Each PE 910 has two input signals 950 and 960 and an output signal 970. The input signal 950 is at least a portion of an IFM to the layer. The input signal 960 is at least a portion of a filter of the layer. In some embodiments, the input signal 950 of a PE 910 includes one or more input operands, and the input signal 960 includes one or more weight operands.

Each PE 910 performs an MAC operation on the input signals 950 and 960 and outputs the output signal 970, which is a result of the MAC operation. Some or all of the input signals 950 and 960 and the output signal 970 may be in an integer format, such as INT8, or floating-point format, such as FP16 or BF16. For the purpose of simplicity and illustration, the input signals and output signal of all the PEs 910 have the same reference numbers, but the PEs 910 may receive different input signals and output different output signals from each other. Also, a PE 910 may be different from another PE 910, e.g., including more, fewer, or different components.

As shown in FIG. 9, the PEs 910 are connected to each other, as indicated by the dash arrows in FIG. 9. The output signal 970 of an PE 910 may be sent to many other PEs 910 (and possibly back to itself) as input signals via the interconnections between PEs 910. In some embodiments, the output signal 970 of an PE 910 may incorporate the output signals of one or more other PEs 910 through an accumulate operation of the PE 910 and generates an internal partial sum of the PE array.

In the embodiments of FIG. 9, the PEs 910 are arranged into columns 905 (individually referred to as “column 905”). The input and weights of the layer may be distributed to the PEs 910 based on the columns 905. Each column 905 has a column buffer 920. The column buffer 920 stores data provided to the PEs 910 in the column 905 for a short amount of time. The column buffer 920 may also store data output by the last PE 910 in the column 905. The output of the last PE 910 may be a sum of the MAC operations of all the PEs 910 in the column 905, which is a column-level internal partial sum of the PE array 900. In other embodiments, input and weights may be distributed to the PEs 910 based on rows in the PE array 900. The PE array 900 may include row buffers in lieu of column buffers 920. A row buffer may store input signals of the PEs in the corresponding row and may also store a row-level internal partial sum of the PE array 900.

In some embodiments, a column buffer 920 may be a portion of the local memory 340 in FIG. 3. The column buffer 920 may be associated with upper memory hierarchies, e.g., the memory 310 in FIG. 3. Data in the column buffer 920 may be sent to the upper memory hierarchies. The column buffer 920 may receive data from the upper memory hierarchies.

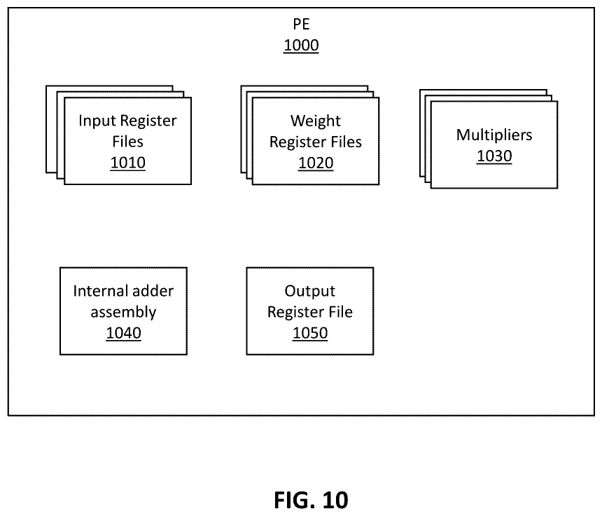

FIG. 10 is a block diagram of a PE 1000, in accordance with various embodiments. The PE 1000 may be an embodiment of the PE 910 in FIG. 9. The PE 1000 may perform MAC operations, e.g., MAC operations using data in integer formats. The PE 1000 may be an example PE in the PE array 350 described above in conjunction with FIG. 3. As shown in FIG. 10, the PE 1000 includes input register files 1010 (individually referred to as “input register file 1010”), weight registers file 1020 (individually referred to as “weight register file 1020”), multipliers 1030 (individually referred to as “multiplier 1030”), an internal adder assembly 1040, and an output register file 1050. In other embodiments, the PE 1000 may include fewer, more, or different components. For example, the PE 1000 may include multiple output register files 1050. As another example, the PE 1000 may include a single input register file 1010, weight register file 1020, or multiplier 1030. As yet another example, the PE 1000 may include an adder in lieu of the internal adder assembly 1040.

The input register files 1010 temporarily store activation operands for MAC operations by the PE 1000. In some embodiments, an input register file 1010 may store a single activation operand at a time. In other embodiments, an input register file 1010 may store multiple activation operand or a portion of an activation operand at a time. An activation operand includes a plurality of input elements (i.e., input elements) in an input tensor. The input elements of an activation operand may be stored sequentially in the input register file 1010 so the input elements can be processed sequentially. In some embodiments, each input element in the activation operand may be from a different input channel of the input tensor. The activation operand may include an input element from each of the input channels of the input tensor, and the number of input elements in an activation operand may equal the number of the input channels. The input elements in an activation operand may have the same XY coordinates, which may be used as the XY coordinates of the activation operand. For instance, all the input elements of an activation operand may be X0Y0, X0Y1, X1Y1, etc.

The weight register file 1020 temporarily stores weight operands for MAC operations by the PE 1000. The weight operands include weights in the filters of the DNN layer. In some embodiments, the weight register file 1020 may store a single weight operand at a time. other embodiments, an input register file 1010 may store multiple weight operands or a portion of a weight operand at a time. A weight operand may include a plurality of weights. The weights of a weight operand may be stored sequentially in the weight register file 1020 so the weight can be processed sequentially. In some embodiments, for a multiplication operation that involves a weight operand and an activation operand, each weight in the weight operand may correspond to an input element of the activation operand. The number of weights in the weight operand may equal the number of the input elements in the activation operand.

In some embodiments, a weight register file 1020 may be the same or similar as an input register file 1010, e.g., having the same size, etc. The PE 1000 may include a plurality of register files, some of which are designated as the input register files 1010 for storing activation operands, some of which are designated as the weight register files 1020 for storing weight operands, and some of which are designated as the output register file 1050 for storing output operands. In other embodiments, register files in the PE 1000 may be designated for other purposes, e.g., for storing scale operands used in elementwise add operations, etc.

The multipliers 1030 perform multiplication operations on activation operands and weight operands. A multiplier 1030 may perform a sequence of multiplication operations on a single activation operand and a single weight operand and generate a product operand including a sequence of products. Each multiplication operation in the sequence includes multiplying an input element in the activation operand and a weight in the weight operand. In some embodiments, a position (or index) of the input element in the activation operand matches the position (or index) of the weight in the weight operand. For instance, the first multiplication operation is a multiplication of the first input element in the activation operand and the first weight in the weight operand, the second multiplication operation is a multiplication of the second input element in the activation operand and the second weight in the weight operand, the third multiplication operation is a multiplication of the third input element in the activation operand and the third weight in the weight operand, and so on. The input element and weight in the same multiplication operation may correspond to the same depthwise channel, and their product may also correspond to the same depthwise channel.

Multiple multipliers 1030 may perform multiplication operations simultaneously. These multiplication operations may be referred to as a round of multiplication operations. In a round of multiplication operations by the multipliers 1030, each of the multipliers 1030 may use a different activation operand and a different weight operand. The different activation operands or weight operands may be stored in different register files of the PE 1000. For instance, a first multiplier 1030 uses a first activation operand (e.g., stored in a first input register file 1010) and a first weight operand (e.g., stored in a first weight register file 1020), versus a second multiplier 1030 uses a second activation operand (e.g., stored in a second input register file 1010) and a second weight operand (e.g., stored in a second weight register file 1020), a third multiplier 1030 uses a third activation operand (e.g., stored in a third input register file 1010) and a third weight operand (e.g., stored in a third weight register file 1020), and so on. For an individual multiplier 1030, the round of multiplication operations may include a plurality of cycles. A cycle includes a multiplication operation on an input element and a weight.

The multipliers 1030 may perform multiple rounds of multiplication operations. A multiplier 1030 may use the same weight operand but different activation operands in different rounds. For instance, the multiplier 1030 performs a sequence of multiplication operations on a first activation operand stored in a first input register file in a first round, versus a second activation operand stored in a second input register file in a second round. In the second round, a different multiplier 1030 may use the first activation operand and a different weight operand to perform another sequence of multiplication operations. That way, the first activation operand is reused in the second round. The first activation operand may be further reused in additional rounds, e.g., by additional multipliers 1030.

The internal adder assembly 1040 includes one or more adders inside the PE 1000, i.e., internal adders. The internal adder assembly 1040 may perform accumulation operations on two or more products operands from multipliers 1030 and produce an output operand of the PE 1000. In some embodiments, the internal adders are arranged in a sequence of tiers. A tier includes one or more internal adders. For the first tier of the internal adder assembly 1040, an internal adder may receive product operands from two or more multipliers 1030 and generate a sum operand through a sequence of accumulation operations. Each accumulation operation produces a sum of two or more products, each of which is from a different multiplier 1030. The sum operand includes a sequence of sums, each of which is a result of an accumulation operation and corresponds to a depthwise channel. For the other tier(s) of the internal adder assembly 1040, an internal adder in a tier receives sum operands from the precedent tier in the sequence. Each of these numbers may be generated by a different internal adder in the precedent tier. A ratio of the number of internal adders in a tier to the number of internal adders in a subsequent tier may be 2:1. In some embodiments, the last tier of the internal adder assembly 1040 may include a single internal adder, which produces the output operand of the PE 1000.

The output register file 1050 stores output operands of the PE 1000. In some embodiments, the output register file 1050 may store an output operand at a time. In other embodiments, the output register file 1050 may store multiple output operands or a portion of an output operand at a time. An output operand includes a plurality of output elements in an IFM. The output elements of an output operand may be stored sequentially in the output register file 1050 so the output elements can be processed sequentially. In some embodiments, each output element in the output operand corresponds to a different depthwise channel and is an element of a different output channel of the output channel of the depthwise convolution. The number of output elements in an output operand may equal the number of the depthwise channels of the depthwise convolution.

Example Method of Computing Activation Functions

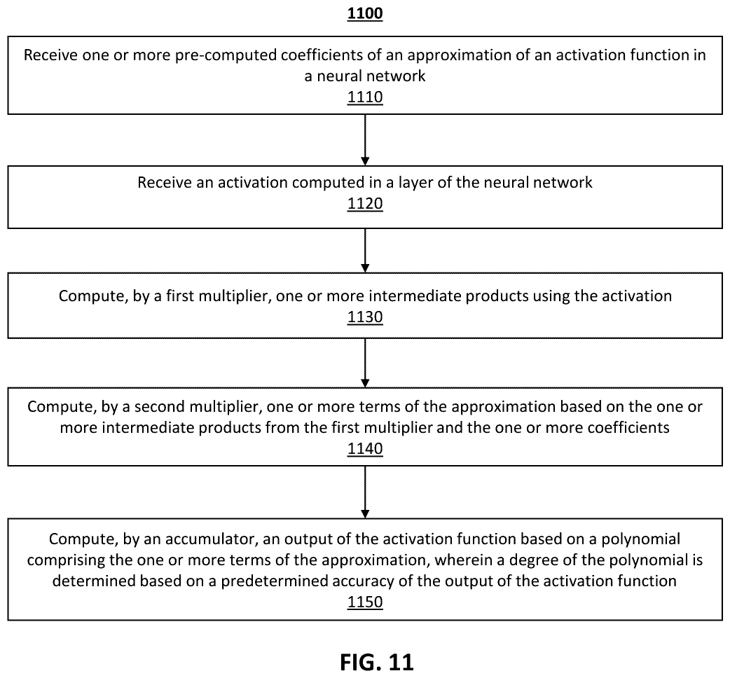

FIG. 11 is a flowchart showing a method 1100 of computing activation functions in neural networks, in accordance with various embodiments. The method 1100 may be performed by the activation function unit 360 in FIG. 3. Although the method 1100 is described with reference to the flowchart illustrated in FIG. 11, many other methods for computing activation functions may alternatively be used. For example, the order of execution of the steps in FIG. 11 may be changed. As another example, some of the steps may be changed, eliminated, or combined.

The activation function unit 360 receives 1110 one or more precomputed coefficients of an approximation of an activation function in a neural network. In some embodiments, the approximation is Taylor series that can approximate the activation function. The one or more precomputed coefficients comprise one or more coefficients of the Taylor series.

The activation function unit 360 receives 1120 an activation computed in a layer of the neural network. In some embodiments, the activation is an output activation of the layer of the neural network.

The activation function unit 360 computes 1130 computing, by a first multiplier, one or more intermediate products using the activation. In some embodiments, the first multiplier computes a first intermediate product in a first clock cycle. After computing the first intermediate product, the first multiplier computes a second intermediate product in a second clock cycle based on the activation and the first intermediate product. In an example, the first intermediate product may be the activation squared, and the second intermediate product may be the activation cubed.

The activation function unit 360 computes 1140 by a second multiplier, one or more terms of the approximation based on the one or more intermediate products from the first multiplier and the one or more coefficients. In some embodiments, the second multiplier computes the one or more terms of the approximation in a sequence of clock cycles by using a different coefficient of the approximation in each clock cycle in the sequence. In some embodiments, the one or more terms of the approximation comprises one or more Taylor series terms.

The activation function unit 360 computes 1150, by an accumulator, an output of the activation function based on a polynomial comprising the one or more terms of the approximation. A degree of the polynomial is determined based on a predetermined accuracy of the output of the activation function. In some embodiments, the degree of the polynomial equals the number of terms minus one. In some embodiments, the activation function unit 360 provides the output of the activation function to another layer of the neural network. The another layer is after the layer in the neural network.

In some embodiments, the activation function unit 360 receives one or more other activations in one or more different clock cycles from a clock cycle in which the activation is received. The one or more other activations are computed in the layer of the neural network. In some embodiments, the activation function unit 360 computes another output of the activation function based on another activation that is computed in the layer of the neural network. The another output of the activation function has a different predetermined accuracy from the output of the activation function.

Example Computing Device

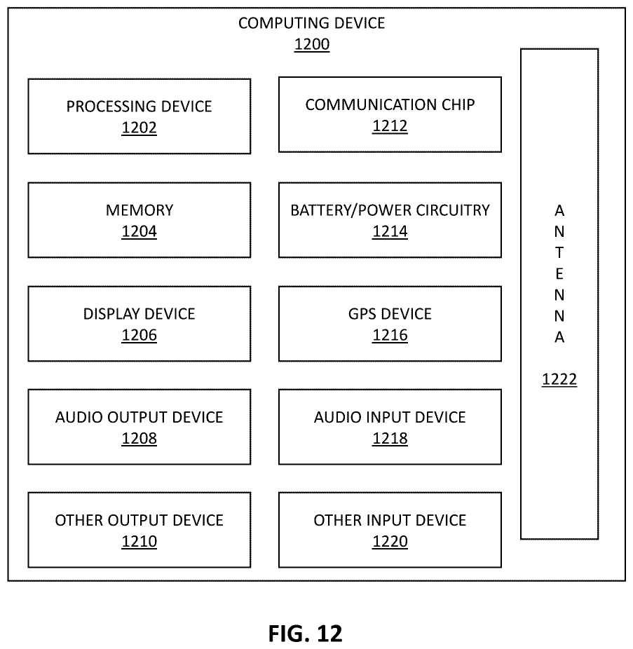

FIG. 12 is a block diagram of an example computing device 1200, in accordance with various embodiments. In some embodiments, the computing device 1200 can be used as at least part of the DNN accelerator 300. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208, but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for computing activation functions in DNNs, e.g., the method 1100 described above in conjunction with FIG. 11 or some operations performed by the DNN accelerator 300 (e.g., the activation function unit 360) described above in conjunction with FIG. 3. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (OR) code reader, any sensor, or a radio frequency identification (RFID) reader.

The computing device 1200 may have any desired form factor, such as a handheld or mobile computer system (e.g., a cell phone, a smart phone, a mobile Internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

### Select Examples

The following paragraphs provide various examples of the embodiments disclosed herein.

Example 1 provides a compute element for computing an activation function, the compute element including a first multiplier configured to compute one or more intermediate products using an activation, the activation computed in a layer of a neural network; a second multiplier configured to compute one or more terms of an approximation of the activation function based on the one or more intermediate products from the first multiplier and one or more coefficients of the approximation; and an accumulator configured to compute an output of the activation function based on a polynomial comprising the one or more terms of the approximation, wherein a degree of the polynomial is determined based on a predetermined accuracy of the output of the activation function.

Example 2 provides the compute element of example 1, where the approximation of the activation function is a Taylor series, and the one or more coefficients of the approximation comprises one or more coefficients of the Taylor series that are computed before the activation is computed.

Example 3 provides the compute element of example 1 or 2, further including a storage unit associated with the accumulator, the storage unit configured to store an intermediate sum computed by the accumulator, where the accumulator is configured to compute the output of the activation function by accumulating the intermediate sum with a term of the approximation computed by the second multiplier.

Example 4 provides the compute element of any of the preceding examples, where the first multiplier is configured to compute the one or more intermediate products by computing a first intermediate product in a first clock cycle; and after computing the first intermediate product, computing a second intermediate product in a second clock cycle based on the activation and the first intermediate product.

Example 5 provides the compute element of any of the preceding examples, where the second multiplier is configured to compute the one or more terms of the approximation in a sequence of clock cycles, and the second multiplier is configured to use a different coefficient of the approximation in each clock cycle in the sequence.

Example 6 provides the compute element of any of the preceding examples, where the compute element is included in a plurality of compute elements for computing outputs of the activation function using a plurality of activations, the plurality of activations is computed in the layer of the neural network and includes the activation, and the plurality of activations is input into different ones of the plurality of compute elements in different clock cycles.

Example 7 provides the compute element of example 6, where a first output of the activation function based on a first activation of the plurality of activations has a higher predetermined accuracy than a second output of the activation function based on a second activation of the plurality of activations, and the first output of the activation function is computed by more compute elements than the second output of the activation function.

Example 8 provides an apparatus for a deep learning operation, the apparatus including one or more processing elements configured to computing one or more activations by performing the deep learning operation in a neural network; a memory configured to store one or more coefficients of an approximation of an activation function in the neural network; and one or more compute elements configured to receive the one or more activations from the one or more processing elements and receive the one or more coefficients from the memory, a compute element including a first multiplier configured to compute one or more intermediate products using an activation of the one or more activations, a second multiplier configured to compute one or more terms of the approximation based on the one or more intermediate products from the first multiplier and the one or more coefficients, and an accumulator configured to compute an output of the activation function based on a polynomial including the one or more terms of the approximation, where a degree of the polynomial is determined based on a predetermined accuracy of the output of the activation function.

Example 9 provides the apparatus of example 8, where the one or more processing elements are coupled to the memory through a data transfer path, and the compute element is on the data transfer path.

Example 10 provides the apparatus of example 8 or 9, where the first multiplier is configured to compute the one or more intermediate products by computing a first intermediate product in a first clock cycle; and after computing the first intermediate product, computing a second intermediate product in a second clock cycle based on the activation and the first intermediate product.

Example 11 provides the apparatus of any one of examples 8-10, where the second multiplier is configured to compute the one or more terms of the approximation in a sequence of clock cycles, and the second multiplier is configured to use a different coefficient of the approximation in each clock cycle in the sequence.

Example 12 provides the apparatus of any one of examples 8-11, where different ones of the one or more activations are input into different ones of the one or more compute elements in different clock cycles.

Example 13 provides the apparatus of example 12, where a first output of the activation function based on a first activation of the one or more activation has a higher predetermined accuracy than a second output of the activation function based on a second activation of the one or more activation, and the first output of the activation function is computed by more compute elements than the second output of the activation function.

Example 14 provides the apparatus of any one of examples 8-13, where the deep learning operation is in a first layer of the neural network, the output of the activation function is input into a second layer of the neural network, and the second layer is after the first layer in the neural network.

Example 15 provides a method for deep learning, including receiving one or more precomputed coefficients of an approximation of an activation function in a neural network; receiving an activation computed in a layer of the neural network; computing, by a first multiplier, one or more intermediate products using the activation; computing, by a second multiplier, one or more terms of the approximation based on the one or more intermediate products from the first multiplier and the one or more coefficients; and computing, by an accumulator, an output of the activation function based on a polynomial including the one or more terms of the approximation, where a degree of the polynomial is determined based on a predetermined accuracy of the output of the activation function.

Example 16 provides the method of example 15, where computing the one or more intermediate products includes computing a first intermediate product in a first clock cycle; and after computing the first intermediate product, computing a second intermediate product in a second clock cycle based on the activation and the first intermediate product.

Example 17 provides the method of example 15 or 16, where computing the one or more terms of the approximation includes computing the one or more terms of the approximation in a sequence of clock cycles by using a different coefficient of the approximation in each clock cycle in the sequence.

Example 18 provides the method of any one of examples 15-17, further including computing another output of the activation function based on another activation that is computed in the layer of the neural network, where the another output of the activation function has a different predetermined accuracy from the output of the activation function.

Example 19 provides the method of any one of examples 15-18, further including receiving one or more other activations in one or more different clock cycles from a clock cycle in which the activation is received, the one or more other activations computed in the layer of the neural network.

Example 20 provides the method of any one of examples 15-19, further including providing the output of the activation function to another layer of the neural network, where the another layer is after the layer in the neural network.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A compute element for computing an activation function, the compute element comprising:
a first multiplier configured to compute one or more intermediate products using an activation, the activation computed in a layer of a neural network;
a second multiplier configured to compute one or more terms of an approximation of the activation function based on the one or more intermediate products from the first multiplier and one or more coefficients of the approximation; and
an accumulator configured to compute an output of the activation function based on a polynomial comprising the one or more terms of the approximation, wherein a degree of the polynomial is determined based on a predetermined accuracy of the output of the activation function.

2. The compute element of claim 1, wherein the approximation of the activation function is a Taylor series, and the one or more coefficients of the approximation comprises one or more coefficients of the Taylor series that are computed before the activation is computed.

3. The compute element of claim 1, further comprising:
a storage unit associated with the accumulator, the storage unit configured to store an intermediate sum computed by the accumulator,
wherein the accumulator is configured to compute the output of the activation function by accumulating the intermediate sum with a term of the approximation computed by the second multiplier.

4. The compute element of claim 1, wherein the first multiplier is configured to compute the one or more intermediate products by:
computing a first intermediate product in a first clock cycle; and
after computing the first intermediate product, computing a second intermediate product in a second clock cycle based on the activation and the first intermediate product.

5. The compute element of claim 1, wherein the second multiplier is configured to compute the one or more terms of the approximation in a sequence of clock cycles, and the second multiplier is configured to use a different coefficient of the approximation in each clock cycle in the sequence.

6. The compute element of claim 1, wherein:
the compute element is included in a plurality of compute elements for computing outputs of the activation function using a plurality of activations,
the plurality of activations is computed in the layer of the neural network and comprises the activation, and
the plurality of activations is input into different ones of the plurality of compute elements in different clock cycles.

7. The compute element of claim 6, wherein:
a first output of the activation function based on a first activation of the plurality of activations has a higher predetermined accuracy than a second output of the activation function based on a second activation of the plurality of activations, and
the first output of the activation function is computed by more compute elements than the second output of the activation function.

8. An apparatus for a deep learning operation, the apparatus comprising:
one or more processing elements configured to computing one or more activations by performing the deep learning operation in a neural network;
a memory configured to store one or more coefficients of an approximation of an activation function in the neural network; and
one or more compute elements configured to receive the one or more activations from the one or more processing elements and receive the one or more coefficients from the memory, a compute element comprising:
a first multiplier configured to compute one or more intermediate products using an activation of the one or more activations,
a second multiplier configured to compute one or more terms of the approximation based on the one or more intermediate products from the first multiplier and the one or more coefficients, and
an accumulator configured to compute an output of the activation function based on a polynomial comprising the one or more terms of the approximation, wherein a degree of the polynomial is determined based on a predetermined accuracy of the output of the activation function.

9. The apparatus of claim 8, wherein the one or more processing elements are coupled to the memory through a data transfer path, and the compute element is on the data transfer path.

10. The apparatus of claim 8, wherein the first multiplier is configured to compute the one or more intermediate products by:
computing a first intermediate product in a first clock cycle; and
after computing the first intermediate product, computing a second intermediate product in a second clock cycle based on the activation and the first intermediate product.

11. The apparatus of claim 8, wherein the second multiplier is configured to compute the one or more terms of the approximation in a sequence of clock cycles, and the second multiplier is configured to use a different coefficient of the approximation in each clock cycle in the sequence.

12. The apparatus of claim 8, wherein different ones of the one or more activations are input into different ones of the one or more compute elements in different clock cycles.

13. The apparatus of claim 12, wherein:
a first output of the activation function based on a first activation of the one or more activation has a higher predetermined accuracy than a second output of the activation function based on a second activation of the one or more activation, and
the first output of the activation function is computed by more compute elements than the second output of the activation function.

14. The apparatus of claim 8, wherein:
the deep learning operation is in a first layer of the neural network,
the output of the activation function is input into a second layer of the neural network, and
the second layer is after the first layer in the neural network.

15. A method for deep learning, comprising:
receiving one or more precomputed coefficients of an approximation of an activation function in a neural network;
receiving an activation computed in a layer of the neural network;
computing, by a first multiplier, one or more intermediate products using the activation;
computing, by a second multiplier, one or more terms of the approximation based on the one or more intermediate products from the first multiplier and the one or more precomputed coefficients; and
computing, by an accumulator, an output of the activation function based on a polynomial comprising the one or more terms of the approximation,
wherein a degree of the polynomial is determined based on a predetermined accuracy of the output of the activation function.

16. The method of claim 15, wherein computing the one or more intermediate products comprises:
computing a first intermediate product in a first clock cycle; and
after computing the first intermediate product, computing a second intermediate product in a second clock cycle based on the activation and the first intermediate product.

17. The method of claim 15, wherein computing the one or more terms of the approximation comprises:
computing the one or more terms of the approximation in a sequence of clock cycles by using a different coefficient of the approximation in each clock cycle in the sequence.

18. The method of claim 15, further comprising:
computing another output of the activation function based on another activation that is computed in the layer of the neural network,
wherein the another output of the activation function has a different predetermined accuracy from the output of the activation function.

19. The method of claim 15, further comprising:
receiving one or more other activations in one or more different clock cycles from a clock cycle in which the activation is received, the one or more other activations computed in the layer of the neural network.

20. The method of claim 15, further comprising:
providing the output of the activation function to another layer of the neural network, wherein the another layer is after the layer in the neural network.
